(19) United States
(12) Patent Application Publication
(10) Pub. No.: US 2012/0099756 A1
(43) Pub. Date: Apr. 26, 2012

(54) Product Identification

(76) Inventors: Faiz Feisal Sherman, Deerfield, OH (US); Mathias Amann, Darmstadt (DE); Ralf Dorber, Oberursel (DE); Dean Larry DuVal, Lebanon, OH (US); Holger Hild, Idstein (DE); Grant Edward Striemer, Hamilton, OH (US)

(21) Appl. No.: 12/908,302

(22) Filed: Oct. 20, 2010

(51) Int. Cl. G06K 9/00

(52) U.S. Cl. 382/100

(57) ABSTRACT

Included are embodiments for product identification. One embodiment of a system includes an image capture device that captures a real-time video image of a retail environment product and a memory component that stores a computer application. In some embodiments, the computer application causes the system to identify the retail environment product from the real-time video image and determine whether a predetermined potential product is similar to the retail environment product. Similarly, in some embodiments, the computer program causes the system to provide, in response to determining that the predetermined potential product is similar to the retail environment product, product identification information for the retail environment product, the product identification information including an altered version of the real-time video image.

### TECHNICAL FIELD

The present application is generally directed to product identification and, more particularly, to identifying a product from a video image.

### BACKGROUND

As mobile devices become more powerful, users now have the ability to utilize positioning hardware and software to locate items of interest. As an example, many mobile devices are configured to utilize in-store maps and global positioning components to determine locations of various products within a store. While these devices often can guide a user to a general location, oftentimes the user suffers shelf confusion due to the fact that such devices are unable to locate the exact location of the product on the shelf. Similarly, oftentimes users may have a general idea of an issue they wish to address, but do not know the exact product they need to address that issue. Consequently, the user often purchases a product that does not perform as desired.

### SUMMARY

Included are embodiments for product identification. One embodiment of a system includes an image capture device that captures a real-time video image of a retail environment product and a memory component that stores a computer application. In some embodiments, the computer application causes the system to identify the retail environment product from the real-time video image and determine whether a predetermined potential product is similar to the retail environment product. Similarly, in some embodiments, the computer program causes the system to provide, in response to determining that the predetermined potential product is similar to the retail environment product, product identification information for the retail environment product, the product identification information including an altered version of the real-time video image.

Similarly, one embodiment of a mobile computing device for product identification includes an image capture device that captures a real-time video image of a retail environment product and a memory component that stores a computer application. In some embodiments, the computer application causes the mobile computing device to identify the retail environment product from the real-time video image and determine whether a predetermined potential product is similar to the retail environment product. Similarly, in some embodiments, the computer program causes the mobile computing device to alter, in response to determining that the predetermined potential product is similar to the retail environment product, the real-time video image to create an altered real-time video image for providing information related to the retail environment product.

Also included are embodiments of a non-transitory computer-readable medium for product identification. At least one embodiment of a non-transitory computer-readable medium stores a first computer application that, when executed by a computer, causes the computer to identify a retail environment product from a real-time video image received from an image capture device and determine whether a predetermined potential product is similar to the retail environment product. Some embodiments are further configured to alter, in response to determining that the predetermined potential product is similar to the retail environment product, the real-time video image to create an altered real-time video image for providing information related to the retail environment product and providing the altered real-time video image for display.

### BRIEF DESCRIPTION OF THE DRAWINGS

The following detailed description of specific embodiments of the present disclosure can be best understood when read in conjunction with the drawings enclosed herewith.

FIG. 1 depicts a computing environment, illustrating a system for product identification, according to embodiments shown and discussed herein;

FIG. 2 depicts a mobile computing device, which may be utilized in the computing environment of FIG. 1 for product identification, according to embodiments shown and described herein;

FIG. 3 depicts an interface for accessing a computer application for product identification, according to embodiments shown and described herein;

FIG. 4 depicts an interface for providing a plurality of user options related to locating a retail environment product, according to embodiments shown and described herein;

FIG. 5 depicts an interface for providing a keyword search for a predetermined potential product, according to embodiments shown and described herein;

FIG. 6 depicts an interface of a real-time video image of a plurality of retail environment products, according to embodiments shown and described herein;

FIG. 7 depicts an interface of an altered real-time video image, illustrating highlighting of a retail environment product that is similar to the predetermined potential product, according to embodiments shown and described herein;

FIG. 8 depicts an interface of an altered real-time video image of a plurality of retail establishment products that are similar to the predetermined potential product, according to embodiments shown and described herein;

FIG. 9 depicts an interface of a real-time video image of a retail environment product and a textual overlay that includes product data, according to embodiments shown and described herein;

FIG. 10 depicts an interface for providing data related to an issue for a user to determine a product to address that issue, according to embodiments shown and described herein;

FIG. 11 depicts an interface for selecting a sub-category of the issue from FIG. 10, according to embodiments shown and described herein;

FIG. 12 depicts an interface for utilizing a first image capture device and a second image capture device to determine a potential product, according to embodiments shown and described herein;

FIG. 13 depicts an interface for receiving an image of a potential product, according to embodiments shown and described herein;

FIG. 14 depicts an interface for utilizing an electronic shopping list that includes a predetermined potential product, according to embodiments shown and described herein;

FIG. 15 depicts an interface of a real-time video image of a retail environment product that is associated with an electronic shopping cart, according to embodiments shown and described herein;

FIG. 16 depicts an interface of a real-time video image of a retail environment product that is similar to a predetermined potential product, as determined from a past user selection, according to embodiments shown and described herein;

FIG. 17 depicts an interface of a real-time video image, providing product data options associated with the retail environment product from FIG. 16, according to embodiments shown and described herein;

FIG. 18 depicts an interface of a real-time video image, illustrating retail environment products that include promotions, according to embodiments shown and described herein;

FIG. 19 depicts an interface of a real-time video image, as well as additional product data associated with the retail environment product, according to embodiments shown and described herein;

FIG. 20 depicts an interface for providing settings for the computer application, according to embodiments shown and described herein;

FIG. 21 depicts a flowchart for identifying a retail environment product, according to embodiments shown and described herein;

FIG. 22 depicts a flowchart for receiving an identifier of a predetermined potential product, according to embodiments shown and described herein;

FIG. 23 depicts a flowchart for receiving an issue and determining a potential product for addressing the issue, according to embodiments shown and described herein;

FIG. 24 depicts a flowchart for receiving an issue and determining a retail environment product to address the issue, according to embodiments shown and described herein;

FIG. 25 depicts a flowchart for receiving an image and determining a potential product from the image, according to embodiments shown and described herein;

FIG. 26 depicts a flowchart for receiving a predetermined potential product via an electronic shopping list, according to embodiments shown and described herein;

FIG. 27 depicts a flowchart for determining a potential product based on a past user selection, according to embodiments shown and described herein;

FIG. 28 depicts a flowchart for determining whether a retail environment product is associated with a promotion, according to embodiments shown and described herein;

The embodiments set forth in the drawings are illustrative in nature and not intended to be limiting of the disclosure defined by the claims. Moreover, individual features of the drawings and disclosure will be more fully apparent and understood in view of the detailed description.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

More specifically, embodiments disclosed herein may be configured as a system, mobile computing device, method, and/or non-transitory computer-readable medium for identifying a product from a real-time video image, as well as providing an altered version of the real-time video. More specifically, in some embodiments, the user may direct an image capture device, such as a camera at a plurality of retail environment products. The image capture device may be configured to capture a real-time video image of the plurality of retail environment products. A retail environment may include grocery stores, department stores, doctor offices, tattoo parlors, beauty salons, tanning salons, store shelves, and/or other areas for providing retail goods and/or services. Similarly, retail environment products may include household care products, beauty and grooming products, and health and well-being products. Some examples of household products include Pampers™ paper towels, Tide™ detergent, Dawn™ soap, Duracell™ batteries, Mr. Clean™ cleaning products, etc. Similarly, some examples of beauty and grooming products include Olay™ beauty products, Head and Shoulders™ shampoo, and Covergirl™ beauty products. Some examples of health and well-being products include Pringles™ potato chips, Vicks cough syrup, Tampax™ tampons, and Crest™ toothpaste. Other products and/or services are also included within the scope of this application.

The image capture device may also be physically and/or communicatively coupled to a mobile computing device and a display device. The mobile computing device may include a memory that stores a computer application that causes the mobile computing device to determine whether a predetermined potential product is among (or is similar to) the retail environment products in the real-time video image. As discussed herein, a predetermined potential product may or may not be specified, but the mobile computing device may use the predetermined potential product to locate related retail environment products.

Additionally, the computer application may cause the mobile computing device to alter the real-time video image to provide information related to one or more of the retail environment products. As described herein, alterations of the real-time video image may include highlighting the product, such as creating a virtual outline around the product, creating a computer graphics interface (CGI) overlay, “graying out” other products, tagging the product with a virtual arrow. Additionally some alterations of the real-time video image include creating a virtual image and/or projection of a product, superimposing the product onto the user, providing text overlays on the real-time video image, providing pop-up windows with information related to the product, and/or otherwise altering the real-time video image. Additionally, the mobile computing device may be configured with network capabilities (e.g., to transfer product information, discounts, consumer profile for rewards, transfer consumption data, etc.).

It should be understood that by graying out products that are not of interest, the mobile computing device may utilize any visual means to de-emphasize non-selected products in the vicinity of the product of interest. This could include converting the non-selected materials to a grey-scale image, fuzzing or de-focusing the images of non-selected products, putting a partial transmission mask over the non-selected products, and/or removing the non-selected products from the shelf image. Other mechanisms for de-emphasis are also included within the scope this disclosure.

As an example, if a user enters a store looking for a predetermined potential product, but does not know exactly where on the shelf that product is located, the user can direct a mobile computing device, which includes an image capture device, toward the shelf. The shelf may include a plurality of retail environment products, and the image capture device can capture a real-time video image of the plurality of retail environment products. Additionally, the user can indicate to the mobile computing device a keyword or other indicator related to the predetermined potential product. With this information, the mobile computing device can identify, from the real-time video image, a retail environment product that corresponds to the predetermined potential product. The mobile computing device can additionally highlight the real-time video image to indicate to the user where the retail environment product is located. With this information, the user can easily locate the retail environment product.

As another example, if a user does not know the exact product, but has an issue to address, the user can indicate, to the mobile computing device, criteria related to that issue. From the information provided by the user, the mobile computing device can determine a retail environment product that best addresses those issues. The mobile computing device may additionally provide a real-time video image that includes a highlighting of the retail environment product that addresses the issue. From the highlighted real-time video image, the user can quickly and easily locate the retail environment product.

As yet another example, if the user is familiar with a plurality of different retail environment products, but cannot decide which to choose, the user can direct the image capture device to those retail environment products. The mobile device can provide a real-time video image that includes the plurality of retail environment products. The user can select the retail environment products from the real-time video image and, in response, the mobile computing device can provide a comparison of the selected products via an altered version of the real-time video image. The comparison may include a price comparison, a user rating comparison (e.g. from a social networking site, from a manufacturer site, from a retailer site, from a third party site, etc.), and/or other comparison. With this information, the user can quickly and easily locate the desired retail environment product.

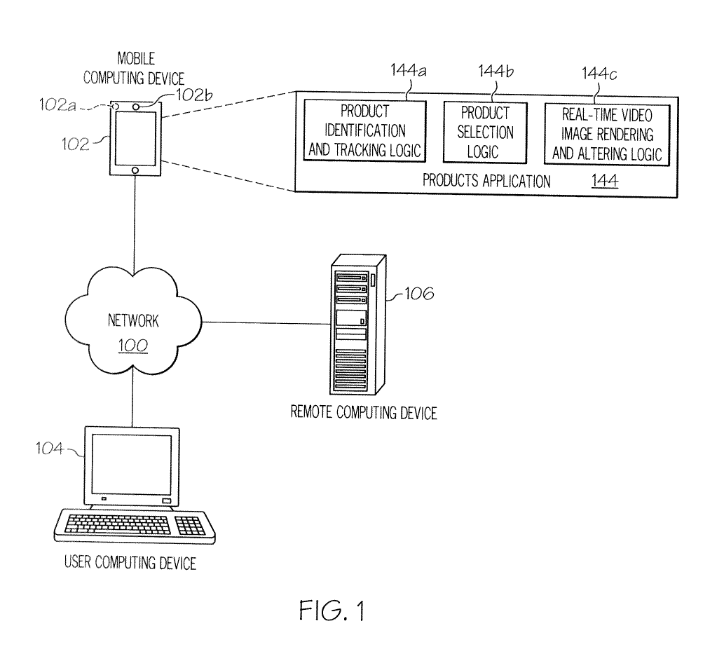

Referring now to the drawings, FIG. 1 depicts a computing environment, illustrating a system for product identification, according to embodiments shown and discussed herein. As illustrated in FIG. 1, a network 100 may include a wide area network, such as the Internet, a local area network (LAN), a mobile communications network, a public service telephone network (PSTN) and/or other network and may be configured to electronically couple a mobile computing device 102, a user computing device 104, and a remote computing device 106.

More specifically, the mobile computing device 102 may include a mobile telephone, personal digital assistant, laptop computer, tablet, and/or other mobile device. Additionally, the mobile computing device 102 may include and/or be coupled to a first image capture device 102a and a second image capture device 102b. The first image capture device 102a may be positioned on a back side of the mobile computing device 102 (as indicated by the dashed circle) and may be configured to capture real-time video images, still images, and/or other images. Similarly, the second image capture device 102b may be positioned opposite the first image capture device 102a and may also be configured to capture still images, real-time video images, and/or other imagery. Further, it should be understood that, while the example of FIG. 1 illustrates the image capture devices 102a, 102b as being physically part of the mobile computing device 102, some embodiments may be configured such that the first image capture device 102a and/or the second image capture device 102b reside external to the mobile computing device 102. In such embodiments, the image capture devices 102a, 102b may communicate image data to the mobile computing device 102 via a wired and/or wireless protocol. Similarly, while the mobile computing device 102 of FIG. 1 may be illustrated with an attached display, this is also merely an example. In some embodiments, the display may reside external to the mobile computing device and may communicate with the mobile computing device 102 via a wired or wireless protocol.

Also included in the mobile computing device 102 is a products application 144, which includes product identification and tracking logic 144a, product selection logic 144b, and real time image rendering and altering logic 144c. As described in more detail below, the product identification and tracking logic 144a may be configured to receive image data (such as real-time video images) and determine, from the received image data, at least one product. Additionally, the product identification and tracking logic 144a may be configured to track the location of the identified product within the image, regardless of movement of the product or the mobile computing device 102. Similarly, the product selection logic 144b may be configured to cause the mobile computing device 102 to determine and/or recommend a product that a user desires. Similarly, the real-time video rendering and altering logic 144c may be configured to render a real-time video image for display, as well as alter the imagery, as described in more detail below.

Also illustrated in FIG. 1 is the user computing device 104. More specifically, the user computing device 104 may be configured to communicate with the mobile computing device 102 via the network 100. In some embodiments, the mobile computing device 102 may send stored data to the user computing device 104 for backup. Similarly, in some embodiments, a user may make one or more preference selections (such as favorite products, allergies, etc.) on the user computing device 104. This data may be sent to the mobile computing device 102 to enhance accuracy of determinations made by the mobile computing device 102 and access remotely stored user profile information.

Similarly, the remote computing device 106 may also be coupled to the network 100 and may be configure to communicate with the mobile computing device 102 (and/or with the user computing device 104) to receive usage data for tracking statistics, purchases, etc. of the user to further enhance performance of the mobile computing device 102.

It should be understood that while the mobile computing device 102, the user computing device 104, and the remote computing device 106 are depicted as PDAs, personal computers and/or servers, these are merely examples. More specifically, in some embodiments any type of computing device (e.g. mobile computing device, personal computer, server, etc.) may be utilized for any of these components. Additionally, while each of these computing devices is illustrated in FIG. 1 as a single piece of hardware, this is also an example. More specifically, each of the computing devices 102-106 may represent a plurality of computers, servers, databases, etc.

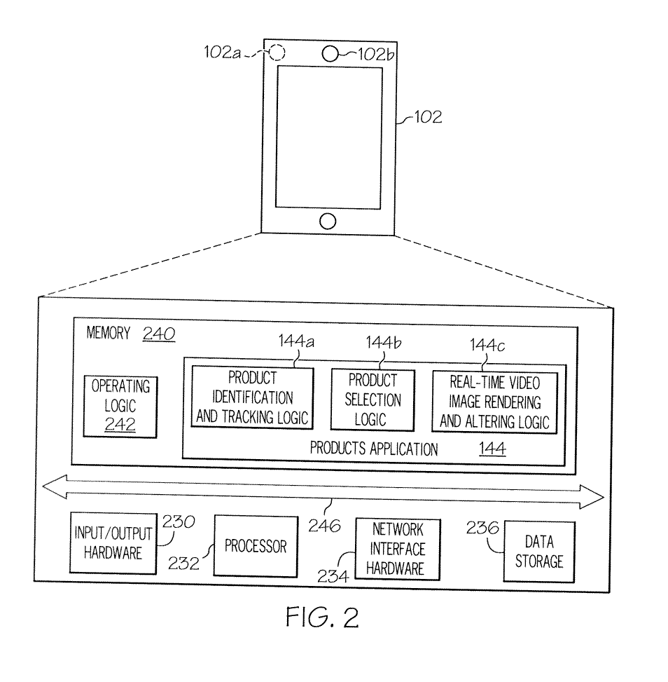

FIG. 2 depicts a mobile computing device 102, which may be utilized in the computing environment of FIG. 1 for product identification, according to embodiments shown and described herein. In the illustrated embodiment, the mobile computing device 102 includes a processor 232, input/output hardware 230, network interface hardware 234, a data storage component 236 (which stores the user data, product data, and/or other data), and a memory component 240. The memory component 240 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the mobile computing device 102 and/or external to the mobile computing device 102.

Additionally, the memory component 240 may be configured to store operating logic 242 and a products application 144. The products application 144 may include a plurality of different pieces of logic, some of which include the product identification and tracking logic 144a, the product selection logic 144b, and the real-time video image rendering and altering logic 144c, each of which may be embodied as a computer program, firmware, and/or hardware, as an example. A local interface 246 is also included in FIG. 2 and may be implemented as a bus or other interface to facilitate communication among the components of the mobile computing device 102.

The processor 232 may include any processing component operable to receive and execute instructions (such as from the data storage component 236 and/or memory component 240). The input/output hardware 230 may include and/or be configured to interface with a monitor, positioning system, keyboard, mouse, printer, image capture device, microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the mobile computing device 102 and other computing devices. The processor may also include and/or be coupled to a graphical processing unit (GPU).

Similarly, it should be understood that the data storage component 236 may reside local to and/or remote from the mobile computing device 102 and may be configured to store one or more pieces of data for access by the mobile computing device 102 and/or other components.

Included in the memory component 240 are the operating logic 242 and the product. The operating logic 242 may include an operating system and/or other software for managing components of the mobile computing device 102. Similarly, as discussed above, the products application 144 may reside in the memory component 240 and may be configured to cause the processor 232 to find a store, identify a product from a received real-time video image, determine a potential product, alter the real-time video image, based on whether the potential product is in the real-time video image, provide links to the user's rewards profile. Other functionality is also included and described in more detail, below.

It should be understood that the components illustrated in FIG. 2 are merely exemplary and are not intended to limit the scope of this disclosure. While the components in FIG. 2 are illustrated as residing within the mobile computing device 102, this is merely an example. In some embodiments, one or more of the components may reside external to the mobile computing device 102. It should also be understood that, while the mobile computing device 102 in FIGS. 1 and 2 is illustrated as a single device, this is also merely an example. In some embodiments, the product identification and tracking functionality, the product selection functionality, and the real-time video image rendering and altering functionality may reside on different devices.

Additionally, while the mobile computing device 102 is illustrated with the product identification and tracking logic 144a, the product selection logic 144b, and the real-time video image rendering and altering logic 144c, within the products application 144, this is also an example. More specifically, in some embodiments, a single piece of logic may perform the described functionality. Similarly, in some embodiments, this functionality may be distributed to a plurality of different pieces of logic, which may reside in the mobile computing device 102 and/or elsewhere. Additionally, while only one application is illustrated as being stored by the memory component 240, other applications may also be stored in the memory component and utilized by the mobile computing device 102.

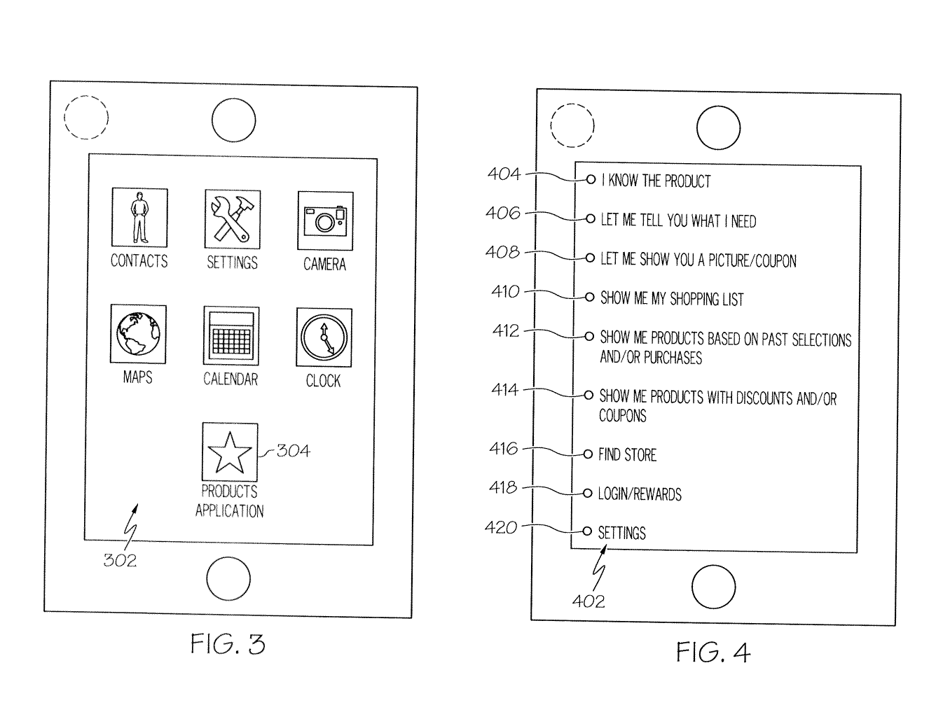

FIG. 3 depicts an interface 302 for accessing the products application 144 for product identification, according to embodiments shown and described herein. As illustrated, the mobile computing device 102 is configured to provide an interface 302 (e.g., via the operating system 142). The interface 302 may be configured to provide the user with access to one or more computer applications that are stored on the mobile computing device 102 and/or elsewhere. As illustrated, the mobile computing device 102 may include and provide options to access a contacts application, a settings application, a camera application, a maps application, a calendar application a clock application, and a products application. As illustrated, the products application 144 may be accessed by selection of the products application option 304. Other applications may also be provided.

It should be understood that while the mobile computing device 102 from FIG. 2 only illustrates the products application 144, this is merely an example. More specifically, as discussed above, the products application 144 may provide additional functionality, such as that provided by the computer applications of FIG. 3. Additionally, while the mobile computing device 102 depicted in FIG. 2 illustrates a single products application 144, other computer applications may also reside in the memory component 240.

FIG. 4 depicts an interface 402 for providing a plurality of user options related to locating a retail environment product, according to embodiments shown and described herein. As illustrated, in response to selecting the products application option 304, an interface 402 may be provided. More specifically, the user may be provided with a “I know the product” option 404, a “let me tell you what I want” option 406, a “let me show you a picture and/or coupon” option 408, a “show me my shopping list” option 410, a “show me products based on past selections” option 412, a “show me products with discounts and/or coupons” option 414. Other options may also be provided, such as an option to locate a retail environment 416 (e.g. via positioning systems), and/or an option for creating and logging into a user account and/or rewards account 418. A settings option 420 may also be provided to provide additional customization.

As an example, some embodiments may be configured such that a user is rewarded for utilizing the products application 144. Such rewards may be accumulated via selection of the products application option 304 and/or via selection of the user account and/or rewards account 418.

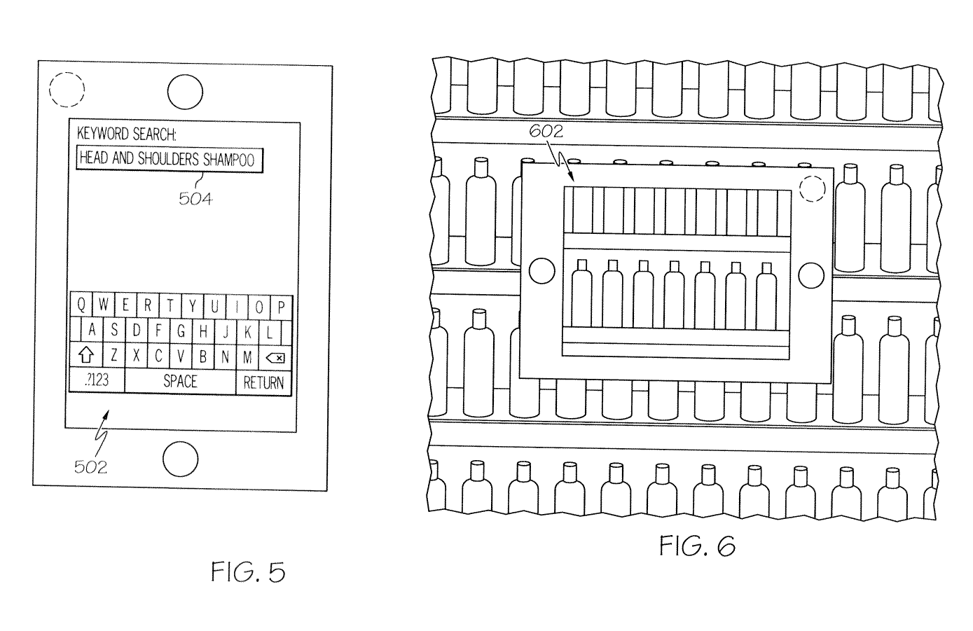

FIG. 5 depicts an interface 502 for providing a keyword search for a predetermined potential product, according to embodiments shown and described herein. As illustrated, in response to selection of the “I know the product” option 404, the user may be provided with an interface 502, which includes a text prompt 504. From the keyword interface 502, the user can identify a potential product that the user wishes to locate. Upon entering the keyword, the mobile computing device 102 can determine the predetermined potential product and/or a list of potential products for location and tracking.

FIG. 6 depicts an interface 602 of a real-time video image of one or more retail environment products, according to embodiments shown and described herein. As illustrated, in response to submitting the keyword in the keyword interface 502, the mobile computing device 102 may be configured to receive, from the first image capture device 102a a real-time video image. The user may direct the first image capture device 102a to a plurality of retail environment products, such as a shelf of retail environment products. As illustrated, a real-time video image of a number of products may be captured by the image capture device 102a. Additionally, as the user moves the mobile computing device 102 to view additional retail environment products, the mobile computing device 102 may store data regarding the retail environment products for identification and/or tracking, as described below.

Additionally, as discussed above, if the first image capture device 102a captures an image of the predetermined potential product within the retail environment products and the user moves the predetermined potential product out of view of the first image capture device 102a, the mobile computing device 102 can continue to track the predetermined potential product. Accordingly, in some embodiments, the mobile computing device 102 may indicate which direction the user should move the first image capture device 102a to locate the predetermined potential product. Similarly, if the mobile computing device 102 has not yet located the predetermined potential product, the mobile computing device may determine an organization of the retail environment products and direct the user on a likely direction to locate the predetermined potential product.

It should also be understood that in some embodiments, upon selection of the products application option 304, from FIG. 3, the interface 602 may be provided. In such embodiments, the user may position the first image capture device 102a such that two (or more) retail environment products are within view. More specifically, the user may locate a first retail environment product and select the image of the first retail environment product from the real-time video image. The user may then locate a second retail environment product and select the image of the second retail environment product from the real time-video image. The user may select a “help me decide” option and may be provided with a comparison of the two (or more) selected retail environment products. The comparison may include a price comparison, a quality comparison, a user review comparison, a price per ounce comparison, and/or other type of comparison. The data for the comparison may be received from and/or linked to a product social network site. From this information the user may acquire a better understanding of the products to decide which to purchase.

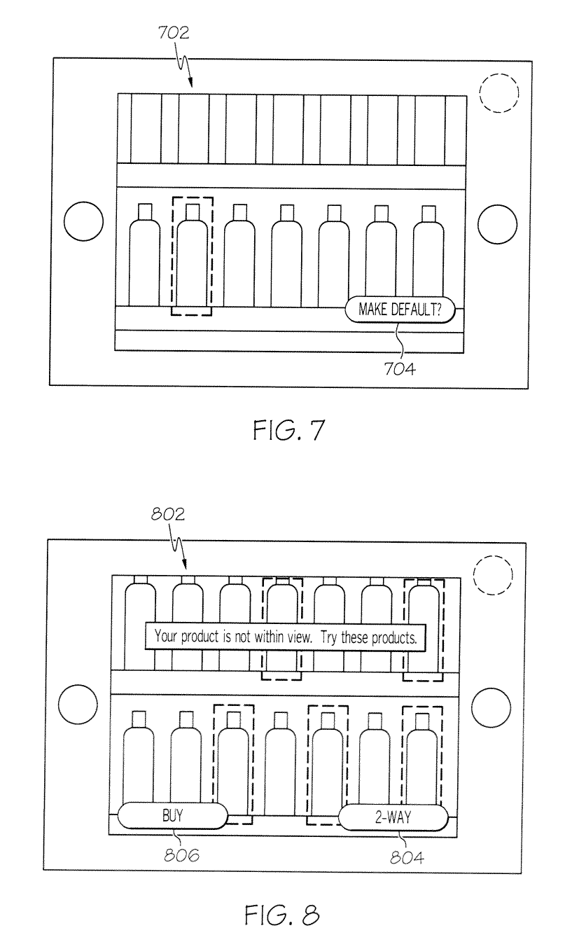

FIG. 7 depicts an interface 702 of an altered real-time video image, illustrating highlighting of a retail environment product that is similar to the predetermined potential product, according to embodiments shown and described herein. As shown, the mobile computing device 102 may be configured to identify the retail environment product that corresponds to the predetermined potential product. Also included is a “make default” option 704 for making the selected retail environment product a default product for this user. In response to selection of the “make default” option 704, the mobile computing device 102 can store information regarding the retail environment product for subsequent selections.

Additionally, in identifying the retail environment product, it should be noted that the retail environment product may be marked (such as with a bar code, a radio frequency identifier (RFID), a color code) for the mobile computing device 102 to identify the product. However, in some embodiments, the retail environment product may be markerless, such that the mobile computing device 102 identifies the retail environment product, using natural features such as product shape, product color, and the like, without the use of a marker.

It should be understood that while in some embodiments, the mobile computing device 102 is configured to identify the product directly, in some embodiments, the mobile computing device may be configured to identity a non-product object and associate the non-product object with the retail environment product. As an example, if the user is looking for a particular type of makeup and the makeup is generally located in a large pink display in the shape of lipstick, upon receiving the real-time video image of the pink display, the mobile computing device 102 can identify that the makeup is in the vicinity and highlight the display (and/or intensify the search for the makeup in that area). Depending on the embodiment, the display may be configured to actively send data to the mobile computing device 102 to facilitate this identification.

Regardless, once the retail environment product is identified, the mobile computing device 102 can alter the real-time video image by highlighting a retail environment product that corresponds to the keyword entered in the text prompt 504, from FIG. 5. The highlighting may take the form of a change in color of the identified retail environment product, a change in color to other retail environment products (e.g., graying out), an outline around the identified retail environment product, a virtual arrow pointing to the product, and/or other types of highlighting. Similarly, while in FIG. 7, the real-time video image is altered by outlining the retail environment product, any of the following product information may be provided as an altered version of the real-time video image: a cost comparator for one or more products , a favorite products list, a favorite products list update, a friends list that includes favorite products of friends of the user, an in-store promotional item list, a next closest item on an electronic shopping list, a recipe that utilizes one or more products, a recommendation for other retail environment products, shopper loyalty information, and/or other information.

It should be understood that, while once the mobile computing device 102 identifies that retail environment product, the mobile computing device 102 can determine the location of the identified retail environment product. This allows the mobile computing device 102 to track motion of the retail environment product relative to the mobile computing device (and/or first image capture device 102a). As an example, if the user moves the first image capture device 102a such that the identified retail environment product moves in the display, the mobile computing device 102 tracks this motion and alters the real-time video image accordingly. Additionally, the mobile computing device 102 can utilize a built-in gyroscope and/or compass to track the retail environment product off screen, as well as alter the real-time video image to indicate in which the retail environment product is located.

FIG. 8 depicts an interface 802 of an altered real-time video image of a plurality of retail environment products that are similar to the predetermined potential product, according to embodiments shown and described herein. As illustrated, in response to the mobile computing device 102 not finding a retail environment product that matches the predetermined potential product entered in the text prompt 504 in FIG. 5, the mobile computing device 102 can identify one or more alternate retail environment products that are similar to the predetermined potential product. Additionally, the mobile computing device 102 can alter the real-time video image to highlight those similar products, similar to the highlighting described with regard to FIG. 7.

Further, the mobile computing device 102 may also provide a “use 2-way image” option 804. Upon selecting the “use 2-way image” option 804, the second image capture device 102b can be activated to capture an image (still and/or real-time video) of the user. The mobile computing device 102 can access the image of the user and determine, from the image of the user, the most appropriate product from the plurality of similar products.

As an example, if the user is looking for a shampoo, the user can enter a predetermined potential product (e.g., “Head and Shoulders”) into the text prompt 504 (FIG. 5). If the predetermined potential product is not among the retail environment products in the real-time video image (or if the keyword is not specific enough to determine the retail environment product), one or more alternate products may be highlighted, as shown in FIG. 8. If the user cannot determine which of the similar retail environment products to choose, the user can activate the second image capture device 102b via selection of the “use 2-way image” option 804. The second image capture device 102b can then capture an image of the user. From the image of the user, the mobile computing device 102 can analyze the image of the user's hair to determine one or more issues with the user hair. From this information, the mobile computing device 102 can determine an appropriate retail environment product. Additionally, in some embodiments, the mobile computing device 102 can utilize other information, such as the keywords entered in the text prompt 504 (FIG. 5), past selections, and/or other data to make this determination.

Also included in FIG. 8 is a “buy online” option 806. As illustrated, if the user does not wish to purchase a retail environment product (because one was not found, because the price is too high, etc.), the “buy online” option 806 may be utilized for purchasing the predetermined potential product via another vendor, such as an online vendor.

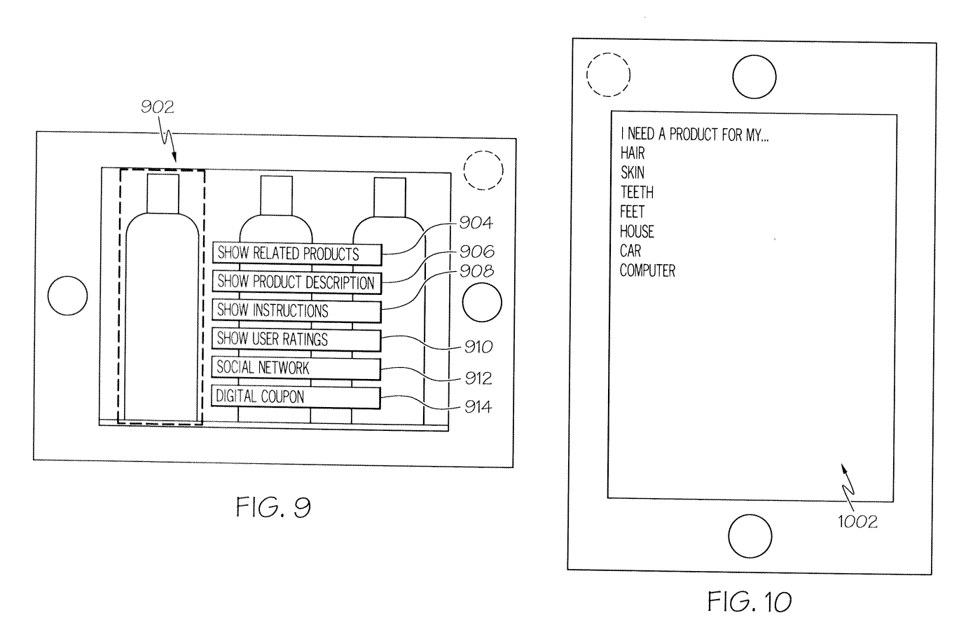

FIG. 9 depicts an interface 902 of a real-time video image of a retail environment product and a textual overlay that includes product data, according to embodiments shown and described herein. As illustrated, in response to selection of the highlighted retail environment product(s), the real-time video image may be altered by inclusion of a text overlay that provides options for suggested complimentary products 904, a product description 906, usage instructions 908, user ratings 910, links to websites 912 (including social networking sites, retail sites, etc.), digital coupons 914, and/or other information. As an example, if the selected product is an electric toothbrush and the user selects the suggested complimentary products option 904, the mobile computing device 102 may provide the user with complimentary products, such as toothbrush head replacements, battery replacements, charger replacements, and/or other data. Similarly, the mobile computing device 102 may also be configured to determine unrelated complimentary products. Referring to the example above, such unrelated complimentary products may include toothpaste that performs best with the electric toothbrush.

FIG. 10 depicts an interface 1002 for providing data related to an issue to determine a product to address that issue, according to embodiments shown and described herein. As illustrated, the mobile computing device 102 may be configured to provide the interface 1002 in response to selection of the “let me tell you what I need” option 406 (FIG. 4). Additionally, the interface 1002 may provide the user may with one or more options for selecting one or more issues that the user is attempting to address. The issue may be related to a physical condition of a person, an emotional condition of a person, a condition of a pet, a condition of an inanimate object, and/or other issues. Similarly, examples of the options for physical issues may include options for hair, skin, teeth, feet, etc. and options for inanimate object issues for house, car, computer, etc. Similarly, options for pet and/or other issues may also be provided.

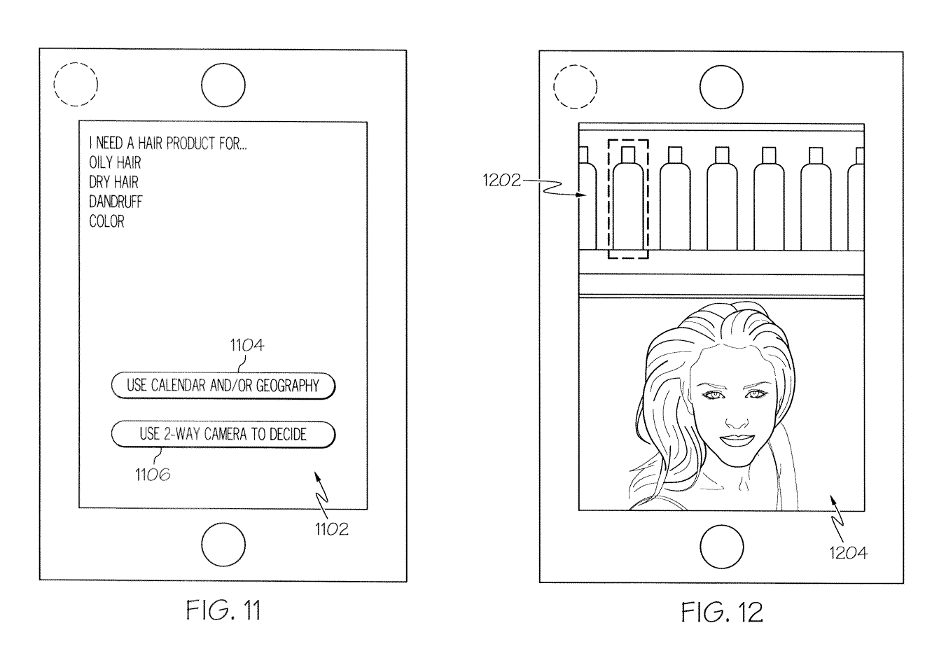

FIG. 11 depicts an interface 1102 for selecting a sub-category of the issue from FIG. 10, according to embodiments shown and described herein. As illustrated, in response to selection of the hair option from FIG. 10, the mobile computing device 102 may provide the interface 1102. The interface 1102 may provide one or more sub-categories to further determine the issue that the user is attempting to address. As shown, the sub-categories that correspond to the “hair” category include oily hair, dry hair, dandruff, and color. Additionally, a “use calendar and/or geography” option 1104 may also be provided for determining the potential product. More specifically, by selecting the “use calendar and/or geography” option 1104, the mobile computing device 102 may access a user calendar to determine the time of year and/or appointments that may affect determination of the potential product. Similarly environmental data, including temperature, humidity (and other weather data), air quality, water hardness, etc. associated with the user location may also be utilized.

As an example, if the user is searching for a feminine hygiene product, but is unsure which of the retail environment products to choose, the user may select the “user calendar and/or geography” option 1104. In response, the mobile computing device 102 may access a second computer application that monitors the user's menstrual cycle. With this information, the mobile computing device 102 can more accurately assist the user in selecting a product.

As another example, if the calendar indicates that the current month is February, a different product may be determined than if the current month is July. Similarly, if the user has an appointment in the near future, this may also affect the potential product determination. Further, in response to selection of the “use calendar and/or geography” option 1104, the mobile computing device 102 may also determine the current location of the user and/or environmental data associated with that location to determine the potential product. More specifically, if the user is currently located in Arizona, the mobile computing device 102 may determine a different product than if the user is currently located in Maine (due to weather, season, type of water, humidity, and/or other factory)

Also included in FIG. 11 is a “use 2-way image” option 1106. Similar to the “use 2-way image” option 804, from FIG. 8, the “use 2-way image” option 1106 can assist the mobile computing device 102 in determining the issue that the user is currently experiencing. More specifically, if the user selects the “use 2-way image capture device to decide” option 1106 in FIG. 11 and the second image capture device 102b captures an image of the user, the mobile computing device 102 can determine whether the user is experiencing oily hair, dry hair, etc. From this information, a potential product can be determined. Similarly, options for tooth color, skin color, wrinkles, and/or other issues may be addressed utilizing this interface.

FIG. 12 depicts a plurality of interfaces 1202, 1204 for utilizing the first image capture device 102a and a second image capture device 102b to determine a potential product, according to embodiments shown and described herein. More specifically, in FIG. 12, the first interface 1202 may be configured to provide the real-time video image of the retail environment products, as captured by the first image capture device 102a. Additionally, the second interface 1204 may provide an image of the user, as captured by the second image capture device 102b. As discussed with regard to FIG. 11, this may assist the mobile computing device 102 in determining the potential product, as well as identifying the potential product among the retail environment products.

Additionally, in some embodiments, the second interface 1204 may be configured to show an altered image of the user after utilizing the predetermined potential product. As an example, if the user (and/or mobile computing device 102) has selected a predetermined potential product, the mobile computing device 102 may alter the image to superimpose a virtual version of the lipstick applied to the user's lips. This allows the user to determine whether the selected lipstick color and/or type is desired prior to purchasing.

Similarly, some embodiments may otherwise alter the real-time video image to illustrate desired the results of using a retail environment product. For example, in some embodiments, the real-time video image may be altered to show a desired hair color, hair style, hair cut, tooth whiteness, skin color, eye color, tattoo, and/or other results.

It should also be understood that in some embodiments, the mobile computing device 102 may further recommend complementary products to the retail environment product and/or predetermined potential product. As an example, if the user selects a lipstick, the mobile computing device 102 may determine the color of the lipstick, the tone of the user's skin and, from that information, recommend a hair coloring product to match the lip color and skin tone.

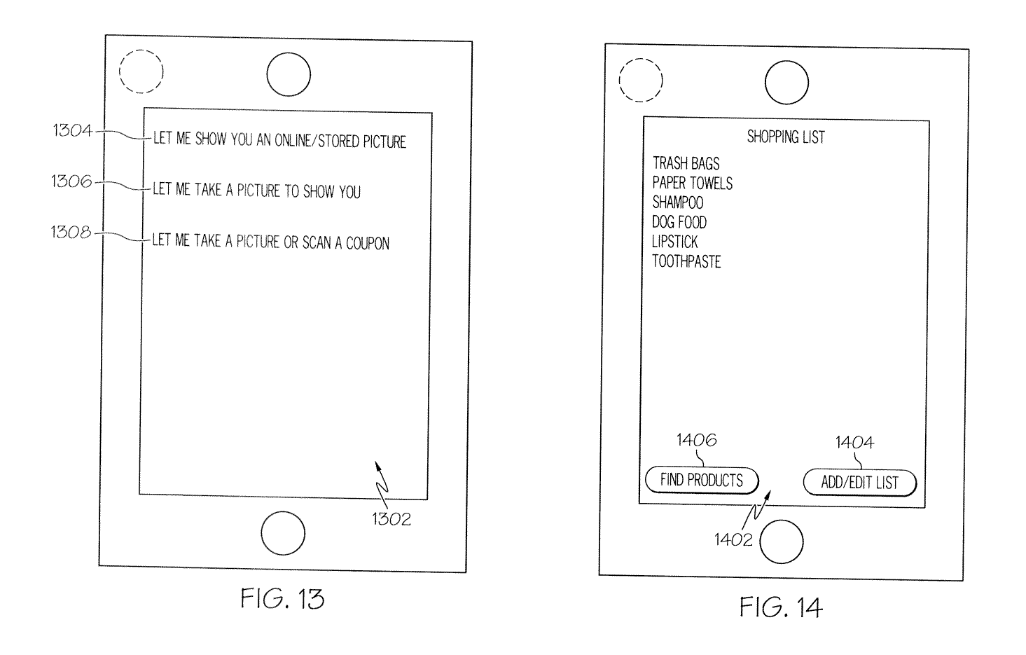

FIG. 13 depicts an interface 1302 for receiving an image of a potential product, according to embodiments shown and described herein. As illustrated, in response to a user selection of the “let me show you a picture and/or coupon” option 408 from FIG. 4, the mobile computing device 102 may be configured to provide the interface 1302. The interface 1302 may be configured to provide one or more sub-options to inputting a picture and/or coupon. More specifically, a “let me show you an online/stored picture” sub-option 1304 may be provided for the user to submit a previously captured image. The image may be stored locally by the mobile computing device 102 and/or accessible through a network connection. Similarly, a “let me take a picture” sub-option 1306 may also be provided to activate the first image capture device 102a and/or the second image capture device 102b. The user can then capture an image of the predetermined potential product. The image may take the form of the product itself, a magazine advertisement, a television advertisement, and/or other version of the predetermined potential product.

Also included is a “let me take a picture or scan a coupon” sub-option 1308. The “let me take a picture or scan a coupon” sub-option 1308 may be configured to cause the mobile computing device 102 to activate the first image capture device 102a, the second image capture device 102b, and/or a scanning device to capture or scan a coupon related to the predetermined potential product.

FIG. 14 depicts an interface 1402 for utilizing an electronic shopping list that includes a predetermined potential product, according to embodiments shown and described herein. As illustrated, in response to selection of the “show me my shopping list” option 410 (FIG. 4), the interface 1402 may be provided, which includes the electronic shopping list. The electronic shopping list may include one or more predetermined potential products that the user may desire to purchase. The predetermined potential products listed may be included in the electronic shopping list via a number of different mechanisms. As an example, the user may simply type the products into the electronic shopping list and/or the mobile computing device 102 may determine a predetermined potential product to be included (e.g. based on a calendar, via communication with another computer application, etc.). Additionally, an add/edit list option 1404 may also be provided for adding, removing, and/or editing the electronic shopping list. The list may be added and/or edited via direct user input, via receiving imagery from the image capture device, via scanning a bar code or other identifier on a product and/or via other mechanisms. Also included is a “find products” option 1406, for finding retail environment products that correspond with the predetermined potential products in the electronic shopping list.

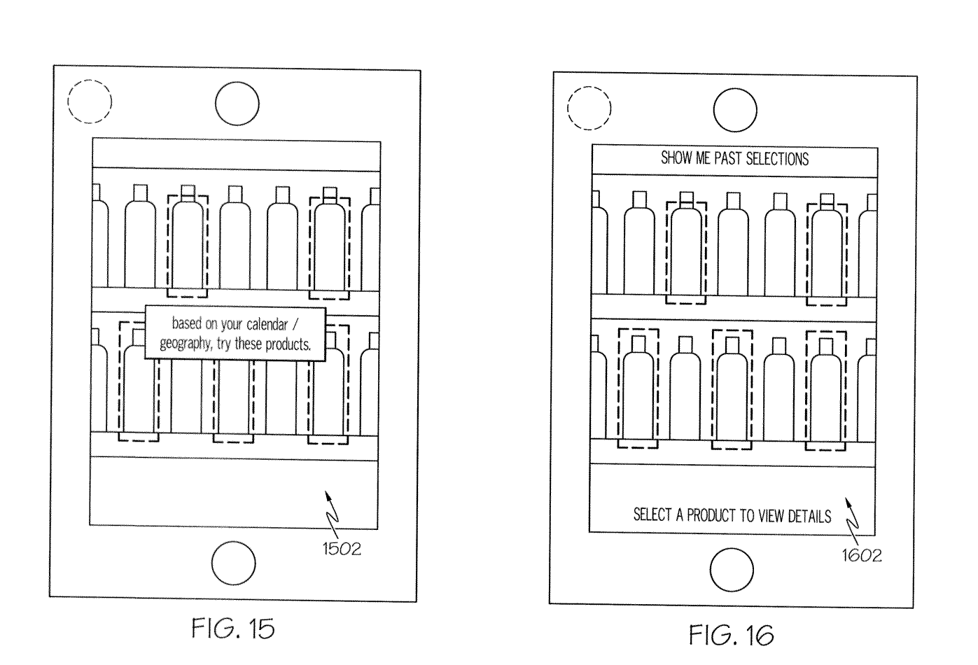

FIG. 15 depicts an interface 1502 of a real-time video image of a retail environment product that is similar to a predetermined potential product identified in the electronic shopping list, according to embodiments shown and described herein. As illustrated, in response to selection of the “find products” option 1406 from FIG. 14, the first image capture device 102a may be activated to capture a real-time video image of one or more retail environment products. Additionally, the mobile computing device 102 can access the electronic shopping list from FIG. 14 and determine whether any of the predetermined potential products from the electronic shopping list are among the retail environment products.

Additionally, as will be understood, the electronic shopping list from FIG. 14 may not specifically identify a product. As an example, the electronic shopping list may include “shampoo,” which may only identify the type of product and not the predetermined potential product itself. Accordingly, the mobile computing device 102 may be configured to determine the predetermined potential products in the electronic shopping list by determining previous selections, default selections, geography, calendar, and/or other mechanisms, as described herein.

FIG. 16 depicts an interface 1602 of a real-time video image of a retail environment product that is similar to a predetermined potential product, as determined from a past user selection, according to embodiments shown and described herein. As illustrated, the interface 1602 may be provided in response to selection of the “show me products based on past selections” option 412 from FIG. 4. More specifically, the interface 1602 may cause the mobile computing device 102 to alter the real-time video image by highlighting one or more products that have been previously selected by the user. As discussed above, the previously selected products may be determined from the electronic shopping list and/or from other selections and/or purchases.

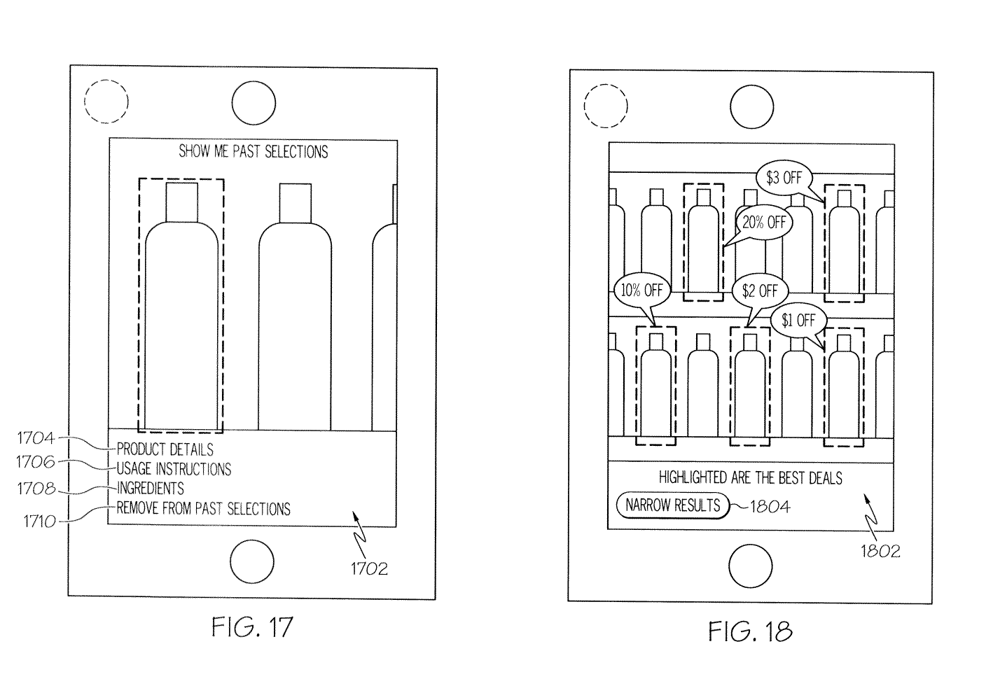

FIG. 17 depicts an interface 1702 of a real-time video image providing product data options associated with the retail environment product from FIG. 16, according to embodiments shown and described herein. As illustrated, in response to selecting one or more highlighted retail environment products from FIG. 16, the mobile computing device 102 may provide an interface 1702, which includes a close-up view of the selected retail environment product in the real-time video image. Also included as an alteration of the real-time video image is a “product details” option 1704, a “usage instructions” option 1706, an “ingredients” option 1708, and a “remove from past selections” option 1710. Other options may also be provided, such as options for virtual coupons, reviews, and social networks.

By selecting the “product details” options 1704, information about the selected product may be provided as an overlay to the real-time video image. Similarly, the “usage instructions” option 1706 may be configured to cause the mobile computing device 102 to provide usage instructions of the selected retail environment product as an alteration of the real-time video image. The “ingredients” option 1708 may be configured to cause the mobile computing device 102 to provide ingredients of the selected in-store image as an alteration of the real-time video image. The “remove from past selections” option 1710 may be configured to cause the mobile computing device 102 to remove the selected retail environment product from future determinations of past selections. Other options may also be provided, as discussed herein.

FIG. 18 depicts an interface 1802 of a real-time video image, illustrating retail environment products that include promotions, according to embodiments shown and described herein. As illustrated, in response to selection of the “show me products with discounts and/or coupons” option 414 (FIG. 4), the interface 1802 may be provided and may include a real-time video image of one or more retail environment products that have promotions and/or coupons. The mobile computing device 102 can alter the real-time video image to highlight one or more retail environment products that have promotions and/or coupons by virtually tagging the retail environment product with discounts.

Additionally included is a “narrow results” option 1804 for reducing the number of highlighted retail environment products. As an example, after selection of the “narrow results” option 1804, the user can indicate whether if the user desires only certain types of products, only certain types of promotions, only a certain amount of money saved, and/or other options for further locate the predetermined potential product form the retail environment products.

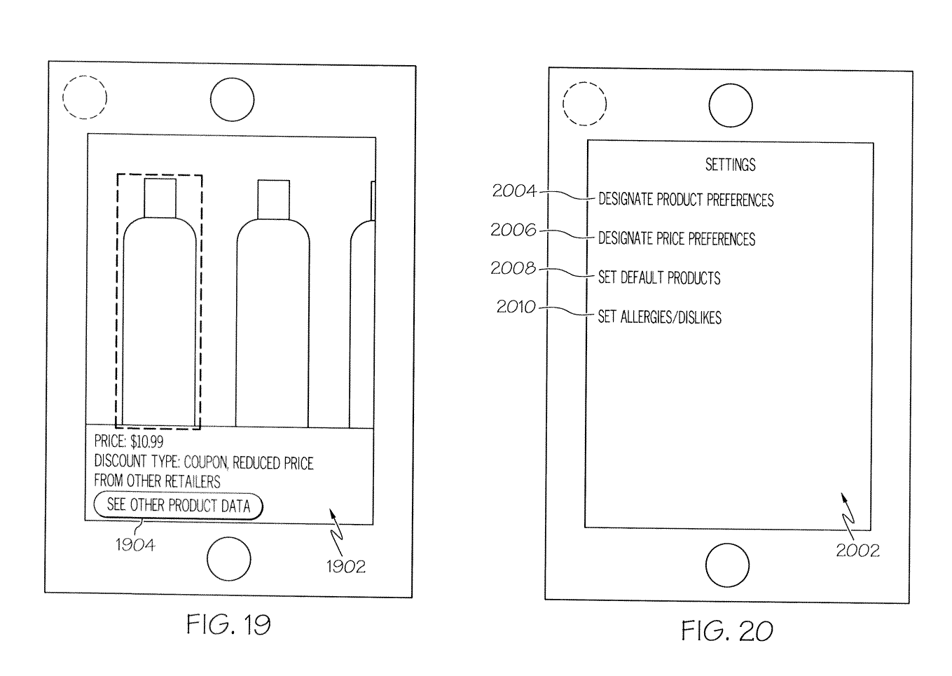

FIG. 19 depicts an interface 1902 of a real-time video image, as well as additional product data associated with the retail environment product, according to embodiments shown and described herein. As illustrated, in response to selection of a retail environment product in the interface 1802 (FIG. 18), the interface 1902 may be provided, and may provide a close-up view of the selected retail environment product from FIG. 18. Additionally, the mobile computing device 102 may further alter the real-time video image from FIG. 18 by including a text overlay that indicates product information, such as price, discount type, and/or other information. Further a “see other product data” option 1904 is provided for providing additional data.

FIG. 20 depicts an interface 2002 for providing settings for the computer application, according to embodiments shown and described herein. As illustrated, in response to selection of the “settings” option 416 (FIG. 4), one or more settings may be provided via an interface 2002. The settings may include a “designate product preferences” option 2004, a “designate price preferences” option 2006, a “set default products” option 2008, and a “set allergies and/or dislikes” option 2010.

The “designate product preferences” option 2004 may be configured to cause the mobile computing device 102 to receive user preferences that correspond to a particular product. More specifically, the user can designate types of products, brands of products, issues to address, and/or other product preferences. Similarly, the “designate price preferences” option may be configured to cause the mobile computing device 102 to receive preferences that correspond to the price of the product. As an example, the user can designate whether he/she only desires to purchase products that are a predetermined percentage below retail price, whether the user desires the least expensive products, the most expensive products, only products with some type of discount, and/or other price preferences.

The “set default products” option 2008 maybe configured to cause the mobile computing device 102 to receive one or more product defaults for the user. In some embodiments, the user can explicitly designate product defaults, such that if the user desires a general product type (e.g., shampoo), the mobile computing device 102 can automatically determine that the user desires Head and Shoulders shampoo. In some embodiments, however, the mobile computing device 102 can determine default products based on past user selections and previous user actions. Additionally, the “set allergies and/or dislikes” option 2010 can cause the mobile computing device 102 to receive allergies and/or dislikes of the user to further filter product results.

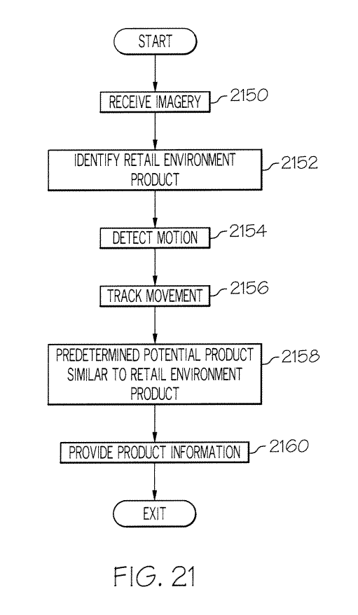

FIG. 21 depicts a flowchart for identifying a retail environment product and/or shelf display, according to embodiments shown and described herein. As illustrated in block 2150, a real-time video image may be received, such as from a first image capture device 102a. Additionally, at block 2152, a retail environment product can be identified from the real-time video image. At block 2154, motion of the first image capture device 102a may be detected, such that the position of the retail environment product changes within the real-time video image. At block 2156, movement of the retail environment product may be tracked within the real-time video image. At block 2158, a determination can be made regarding whether a predetermined potential product is similar to the retail environment product. At block 2160, in response to determining that the predetermined potential product is similar to the retail environment product, product information for the retail environment product may be provided, where the product information includes an altered version of the real-time video image.

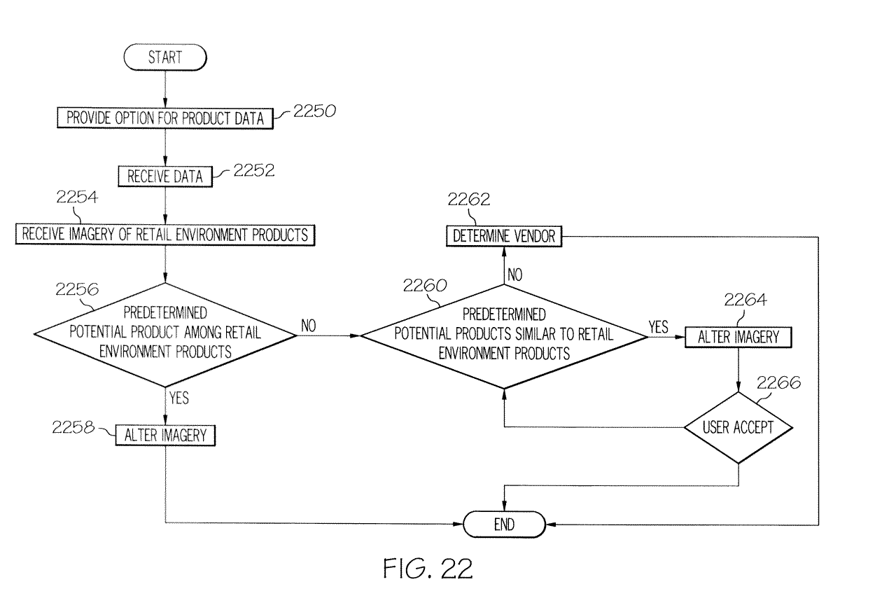

FIG. 22 depicts a flowchart for receiving an identifier of a predetermined potential product, according to embodiments shown and described herein. As illustrated, in block 2250, an option for a user to enter data for a predetermined potential product may be provided. At block 2252, the data may be received from the user. At block 2254, a real-time video image of a plurality of retail environment products may be received. At block 2256, a determination can be made regarding whether the potential product is included within the plurality of retail environment products. If so, at block 2258, the real-time video image may be altered to identify the predetermined potential product. Additional product information may also be provided. If not, at block 2260, a determination may be made regarding whether any of the plurality of retail environment products within the real-time video image are similar to the predetermined potential product. If not, at block 2262, a vendor that provides the predetermined potential product may be determined and an option to purchase the predetermined potential product from that vendor may be provided. If there are alternate products that are similar to the predetermined potential product, at block 2264, the real-time video image may be altered to identify the alternate products. At block 2266, a determination may then be made regarding whether the user accepts the alternate product. If so, the process may end. If, however, the user does not accept the alternate product, the process may return to block 2260 and/or indicate that no product is in stock.

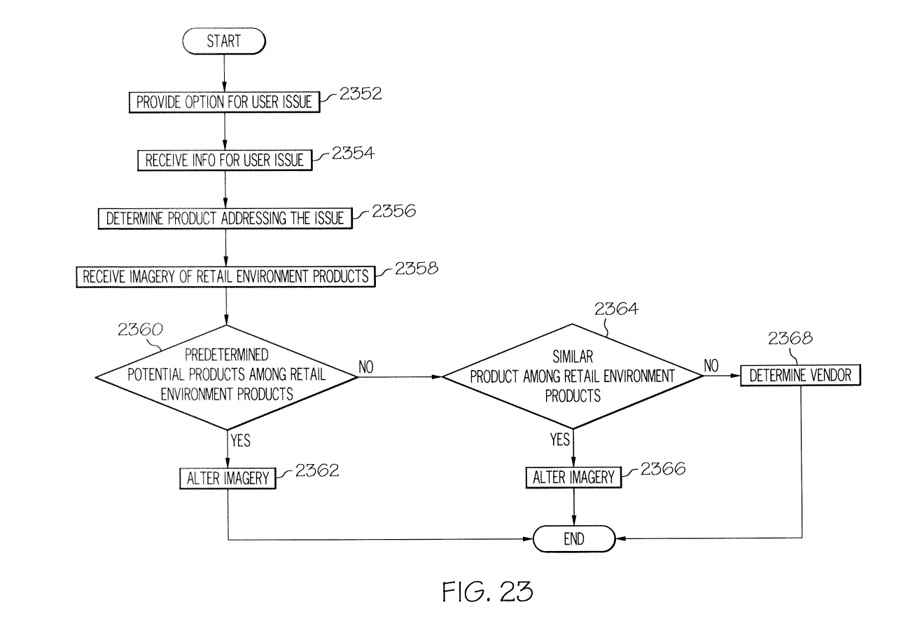

FIG. 23 depicts a flowchart for receiving an issue and determining a potential product for addressing the issue, according to embodiments shown and described herein. As illustrated in block 2352, an option for a user to identify an issue may be provided. As discussed above, the issue may relate to a user bodily issue, an inanimate object issue, a pet issue, and/or another issue. Additionally, at block 2354, user information regarding the issue may be received. At block 2356, a product that addresses the issue may be determined. At block 2358, a real-time video image of a plurality of retail environment products may be received. At block 2360, a determination may be made regarding whether the predetermined product is among (or similar to) the plurality of retail environment products in the real-time video image. If so, the real-time video image may be altered to highlight the determined product. Additional product data may also be provided. If not, at block 2364, a determination can be made regarding whether an alternate product to the determined product is among the plurality of retail environment products. If so, the real-time video image may be altered to highlight the alternate product and provide additional product data. If not, at block 2368, a vendor that provides the determined product is determined and a user option to purchase is provided and an option to purchase the determined product from that vendor is provided.

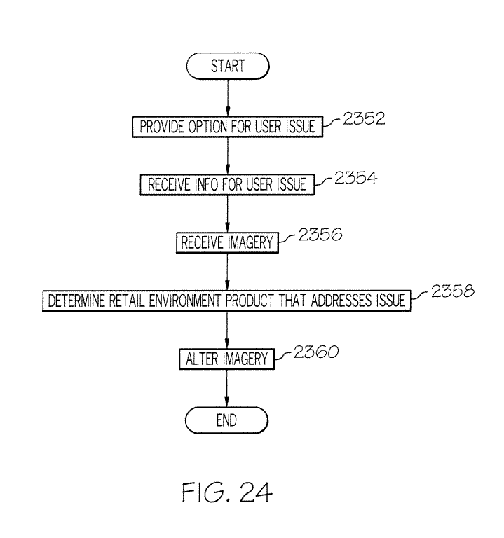

FIG. 24 depicts a flowchart for receiving an issue and determining a retail environment product to address the issue, according to embodiments shown and described herein. As illustrated in block 2450, an option for a user to identify an issue is provided. At block 2452, user information related to the issue is received. At block 2456, a real-time video image of a plurality of retail environment products is received. At block 2458, a determination can be made regarding which of the plurality of retail environment products most closely addresses the issue. At block 2460, the real-time video image may be altered to highlight the determined product(s).

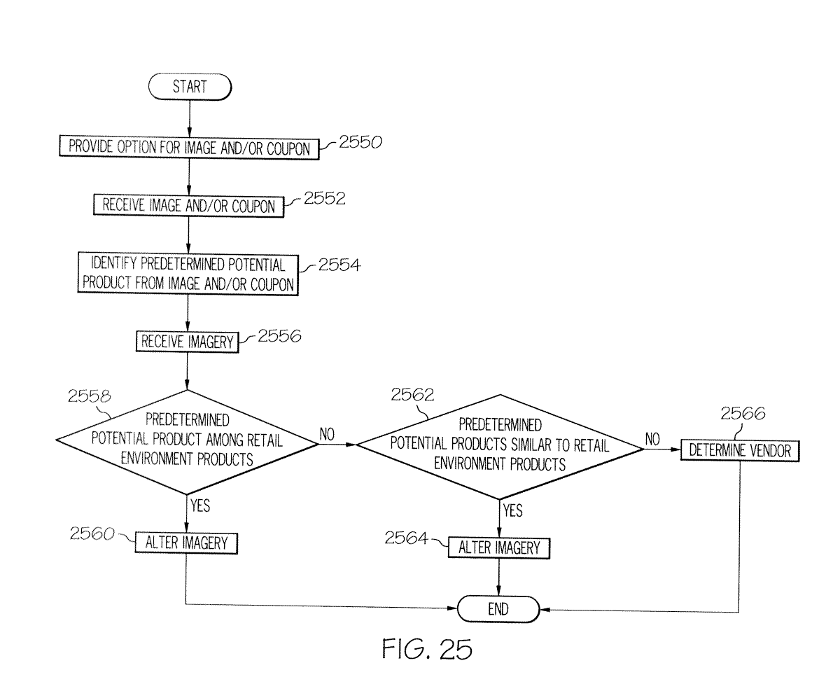

FIG. 25 depicts a flowchart for receiving an image and determining a potential product from the image, according to embodiments shown and described herein. As illustrated in block 2550, an option for a user to input an image and/or a coupon for a predetermined potential product may be provided. At block 2552, an image and/or coupon may be received. At block 2554, the predetermined potential product may be identified from the received image and/or coupon. At block 2556, a real-time video image of a plurality of retail environment products may be received. At block 2558, a determination can be made regarding whether the predetermined potential product is among (or similar to) the plurality of retail environment products. If so, at block 2560, the real-time video image may be altered to highlight the predetermined potential product and provide the other product information. If not, at block 2562, a determination can be made regarding whether any alternate products of the plurality of retail environment products are similar and/or have a similar promotion as the predetermined potential product. If so, the real-time video image may be altered to highlight the alternate products and indicate the similar promotions. If not, at block 2566, a vendor that provides the predetermined potential product and promotion may be determined and provided to the user with an option to purchase.

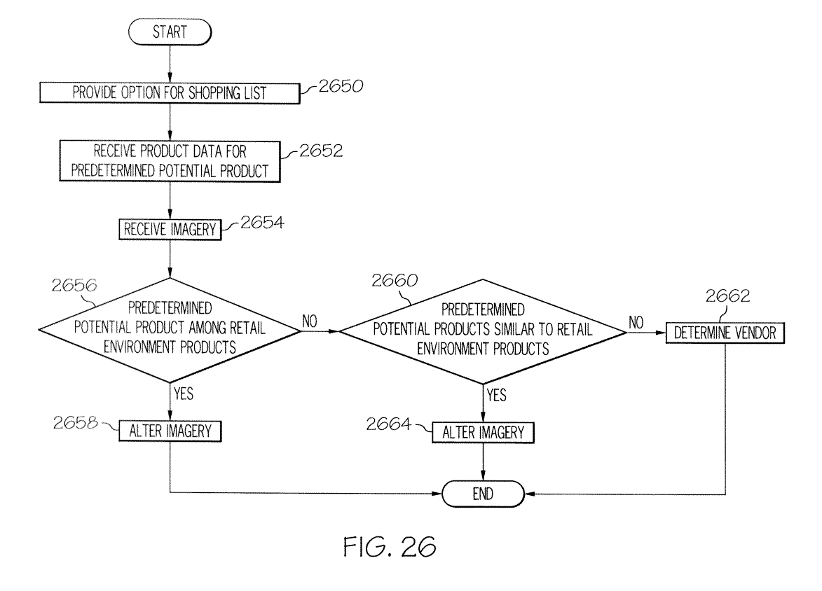

FIG. 26 depicts a flowchart for receiving a predetermined potential product via an electronic shopping list, according to embodiments shown and described herein. As illustrated in block 2650, an option for creation of an electronic shopping list may be provided. At block 2652, product data that identifies one or more predetermined potential products for the electronic shopping list may be received. At block 2654, a real-time video image of a plurality of retail environment products may be received. At block 2656, a determination can be made regarding whether the one or more predetermined potential products is among (or similar to) the plurality of retail environment products. If so, the real-time video image may be altered to highlight the one or more predetermined potential products. If not, at block 2660, a determination can be made regarding whether any alternate products of the plurality of retail environment products are similar to the one of more predetermined potential products. If so, at block 2664, the real-time video image may be altered to the highlight the alternate products. If not, at block 2662, a vendor that provides the predetermined potential product may be determined and an option to purchase may be provided to the user.

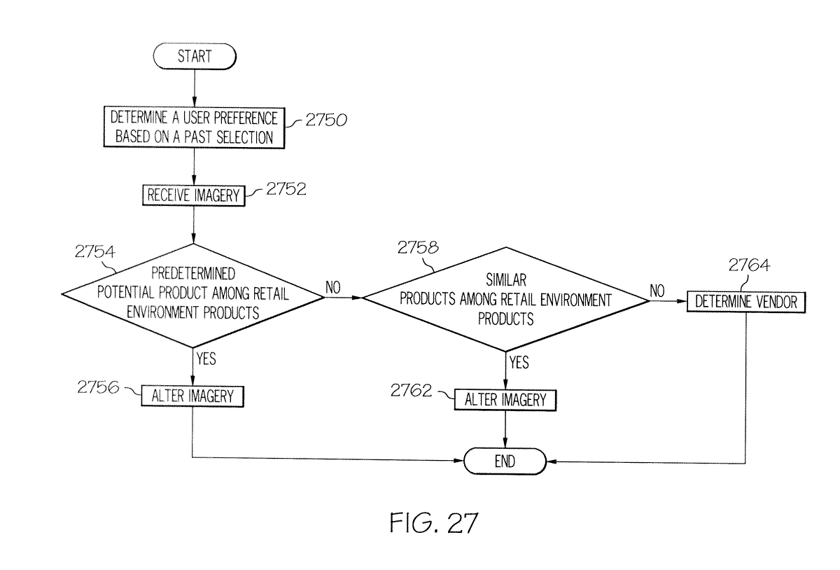

FIG. 27 depicts a flowchart for determining a potential product based on a past user selection, according to embodiments shown and described herein. As illustrated in block 2760, a user preference regarding one or more predetermined potential products may be determined, based on a previous selection. At block 2752, a real-time video image of a plurality of retail environment products may be received. At block 2754, a determination can be made, from the real-time video image, whether any of the at least one predetermined potential products is among (or similar to) the plurality of retail environment products. If so, at block 2756, the real-time video image may be altered to highlight the at least one predetermined potential products and provide other product data. If not, at block 2758, a determination can be made, from the real-time video image, whether any alternate products are similar to the at least one predetermined potential products, are among the plurality of retail environment products. If there are alternate products, at block 2762, the real-time video image may be altered to highlight the alternate product and provide other product information. If not, at block 2760, a vendor that provides the predetermined potential product may be determined. Additionally, an option to purchase may also be provided.

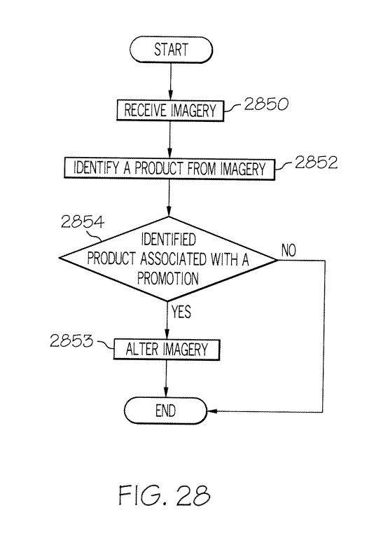

FIG. 28 depicts a flowchart for determining whether a retail environment product is associated with a promotion, according to embodiments shown and described herein. As illustrated in block 2850, a real time video image of a plurality of retail environment products may be received. At block 2852, at least one of the plurality of retail environment products may be identified form the real-time video image. At block 2854, a determination can be made regarding whether the identified at least one retail environment products is associated with a coupon and/or promotion. If not, the process may end. If so, at block 2856, the real-time video image may be altered to highlight the identified at least one retail environment product with an associated coupon and/or promotion and provide other product data.

It should also be understood that, unless a term is expressly defined in this specification using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present disclosure unless so stated. To the extent that any term recited in the claims at the end of this patent is referred to in this patent in a manner consistent with a single meaning, that is done for sake of clarity only so as to not confuse the reader, and it is not intended that such a claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments have been illustrated and described, it would be understood to those skilled in the art that various other changes and modifications can be made without departing from the spirit and scope of the disclosure. It is therefore intended to cover in the appended claims all such changes and modifications that are within the scope of this disclosure.

What is claimed is:

1. A system for product identification, comprising:
an image capture device that captures a real-time video image of a retail environment product;
a memory component that stores a first computer application, the first computer application causing the system to perform at least the following:
identify the retail environment product from the real-time video image;
determine whether at least one predetermined potential product is similar to the retail environment product; and
in response to determining that the predetermined potential product is similar to the retail environment product, provide product identification information for the retail environment product, the product identification information including an altered version of the real-time video image; and
a display device for displaying the altered version of the real-time video image, the display device tracking the retail environment product in the altered version of the real-time video image.

2. The system of claim 1, the first computer application further causing the system to receive data related to a preference of a user for the predetermined potential product, which includes at least one of the following: a user profile, a past selection of the user, calendar data for the user, and environmental data associated with a location of the user.

3. The system of claim 1, further comprising a second image capture device for capturing an image of a user, wherein the image includes at least one of the following: a still image and a real-time video image.

4. The system of claim 1, wherein the memory component stores a second computer application that facilitates storage of at least one of the following, when executed in conjunction with the first computer application: data regarding a physical condition of a user, data regarding an emotional condition of the user, data regarding an electronic shopping list, data regarding a recipe, data regarding a favorite products list, data regarding a friends list, data regarding purchase history, data regarding application usage, and data regarding shopper loyalty.

5. The system of claim 1, wherein the system identifies the retail environment product from natural features on the product, without use of a marker.

6. The system of claim 1, the first computer application further causing the system to identify, in response to a determination that the predetermined potential product is not among the retail environment product, an alternate product from the real-time video image and provide information related to the alternate product.

7. The system of claim 1, wherein creating the altered version of the real-time video image includes at least one of the following: highlight the retail environment product displayed in the real-time video image, provide a coupon for the retail environment product, provide user ratings for the retail environment product, provide a recommendation for other products, provide a cost comparator, provide a favorite products list update, provide in-store promotional item list, provide a next item on an electronic shopping list, provide a next closest item on the electronic shopping list, provide instructions for using the retail environment product, and provide usage information related to the retail environment product.

8. A mobile computing device for product identification, comprising:
an image capture device that captures a real-time video image of a retail environment product;
a memory component that stores a computer application, the computer application causing the mobile computing device to perform at least the following:
identify the retail environment product from the real-time video image;
determine whether a predetermined potential product is similar to the retail environment product;
and in response to determining that the predetermined potential product is similar to the retail environment product, altering the real-time video image to create an altered real-time video image for providing information related to the retail environment product; and
a display device for displaying the altered real-time video image.

9. The mobile computing device of claim 8, further comprising a second image capture device for capturing an image of a user, the image of the user including at least one of the following: a still image and a real-time video image.

10. The mobile computing device of claim 8, wherein the computer application stores at least one of the following: information regarding a physical condition of a user, information regarding an emotional condition of the user, information regarding an electronic shopping list, information regarding a recipe, information regarding a favorite products list, information regarding a friends list, information regarding a user profile, and information regarding shopper loyalty.

11. The mobile computing device of claim 8, wherein the memory component further causes the mobile computing device to receive at least one of the following: data related to a past selection of the user, calendar data for a user, and environmental data associated with a location of the user.

12. The mobile computing device of claim 8, wherein the computer application further causes the mobile computing device to perform at least the following:
identify, in response to a determination that the predetermined potential product is not similar to the retail environment product, an alternate product from the real-time video image; and
provide information related to the alternate product.

13. The mobile computing device of claim 8, wherein the altered the real-time video image includes at least one of the following: highlight the retail environment product displayed in the real-time video image, provide a coupon for the retail environment product, provide user ratings for the retail environment product, provide a recommendation for other products, provide instructions for using the retail environment product, and provide usage information related to the retail environment product.

14. The mobile computing device of claim 8, wherein the mobile computing device identifies the retail environment product from natural features on the product, without use of a marker.

15. A non-transitory computer-readable medium for product identification that stores a first computer application that, when executed by a computer, causes the computer to perform at least the following:
identify a retail environment product from a real-time video image received from an image capture device;
determine whether a predetermined potential product is similar to the retail environment product;
in response to determining that the predetermined potential product is similar to the retail environment product, alter the real-time video image to create an altered real-time video image for providing information related to the retail environment product; and
provide the altered real-time video image for display.

16. The non-transitory computer-readable medium of claim 15, wherein the non-transitory computer-readable medium further stores a second computer application that facilitates storage of user data, the user data including information regarding at least one of the following: a physical condition of a user, an emotional condition of the user, an electronic shopping list, a recipe, a favorite products list, a friends list, and shopper loyalty information, wherein the second computer application is executed in conjunction with the first computer application.

17. The non-transitory computer-readable medium of claim 15, the first computer application causing the computer to identify the retail environment product from natural features on the product, without use of a marker.

18. The non-transitory computer-readable medium of claim 15, the first computer application further causing the computer to receive at least one of the following: data related to a past selection of a user, calendar data for a user, and environmental data associated with a location of the user.

19. The non-transitory computer-readable medium of claim 15, the first computer application further causing the computer to identify, in response to a determination that the predetermined potential product is not similar to the retail environment product, an alternate product from the real-time video image and provide information related to the alternate product.

20. The non-transitory computer-readable medium of claim 15, wherein providing information related to the retail environment product includes altering the real-time video image by performing at least one of the following: highlight the retail environment product displayed in the real-time video image, provide a coupon for the retail environment product, provide user ratings for the retail environment product, provide a recommendation for other products, instructions for using the retail environment product, and provide usage information related to the retail environment product.
